(19) United States
(12) Patent Application Publication
(10) Pub. No.: US 2023/0401466 A1
(43) Pub. Date: Dec. 14, 2023

(54) METHOD FOR TEMPORAL KNOWLEDGE GRAPH REASONING BASED ON DISTRIBUTED ATTENTION

(71) Applicant: Huazhong University of Science and Technology, Wuhan City (CN)

(72) Inventors: Feng ZHAO, Wuhan City (CN); Kangzheng LIU, Wuhan City (CN); Hai JIN, Wuhan City (CN)

(21) Appl. No.: 17/961,798

(22) Filed: Oct. 7, 2022

(30) Foreign Application Priority Data
Jun. 10, 2022 (CN) 202210658296.0

(51) Int. Cl. G06N 5/04; G06N 5/022; G06N 3/0499; G06F 17/16

(52) U.S. Cl. CPC G06N 5/04; G06N 5/022; G06N 3/0499; G06F 17/16

(57) ABSTRACT

The present invention relates to a method for temporal knowledge graph reasoning based on distributed attention, comprising: recombining a temporal knowledge graph in a temporal serialization manner, accurately expressing the structural dependencies between time-evolution features and temporal subgraphs, and then extracting historical repetition facts and historical frequency information based on the sparse matrix storing historical subgraph information; assigning, by the query fact, initial first-layer attention to the facts that are historically repeated using an attention mechanism, and then by capturing the latest changes in the historical frequency information, assigning attention reward and punishment of the second-layer attention to the scores of the first-layer attention, respectively, to make attention more adaptable to time-varying features; finally, using the scores of the two layers of attention to make reasoning-based prediction about future events. Compared with traditional prediction methods, the present invention endows learnable distributed attention on different historical timestamps instead of obtaining a fixed embedding representation through an encoder, so that the model has better ability to solve time-varying problems.

### BACKGROUND OF THE INVENTION

### 1. Technical Field

The present invention relates to temporal knowledge graph reasoning, and more particularly to a method for temporal knowledge graph reasoning based on distributed attention, and a computing model for modeling sequences of temporal knowledge subgraphs based on distributed attention so as to address issues related to the time-varying nature of a temporal knowledge graph.

### 2. Description of Related Art

A temporal knowledge graph is a knowledge graph different from the traditional knowledge graphs with its additional temporal dimension, making its composition include entities (nodes), relations (edges), and timestamps, whose information is usually represented in the form of a knowledge quadruple (s, p, o, t) , where s represents a subject entity, p represents a relation, o represents an object entity, and t represents the relevant time information. For example, (Golden State Warriors, Championship, NBA, 2018) states that Golden State Warriors won the champion of the National Basketball Association in 2018. It is clear that the temporal dimension significantly enhances the ability of expression of a knowledge graph for real-world scenarios.

In recent years, temporal knowledge graphs have been well developed and extensively used in various areas such as crisis warning, stock prediction, etc., yet many problems have been observed. For example, many knowledge graphs are essentially incomplete as they lack for some valuable facts. Besides, a temporal knowledge graph is actually a chronological sequence of knowledge subgraphs, with every timestamp subgraph having its own information of entities, relations, and structures. Insufficient modeling for temporal evolution model of a temporal knowledge graph also significantly degrades temporal knowledge graph reasoning in terms of accuracy. The method for temporal knowledge graph reasoning based on distributed attention assigns attention in a distributed manner to historical information of different timestamps instead of obtaining the unique embedding representation of historical entity through learning, and therefore pays sufficient attention to distributed information across different temporal subgraphs.

Temporal knowledge graph reasoning is essentially about predicting loss facts on specific timestamps. Particularly, the use of only information on the historical timestamps would make tasks for predicting future events more meaningful. Some static reasoning methods, such as those based on embedding, like TransE and RotatE; those based on reinforcement learning, like DeepPath and MINERVA; and those based on graph convolutional networks, like R-GCN and Comp-GCN, nevertheless, completely ignore the time dimension of temporal knowledge graphs.

Studies of the attention mechanism stem from cognitive psychology and neuroscience. Human eyes can focus on a site of interest after a glance, and then pay more attention to this site to get fine target information, while less concerning other areas, thereby preventing information overload. This is an ability allows human to fast extract valuable information from extensive information using limited resources. The so-called attention mechanism is a mechanism to achieve focus on local information. For example, for a certain part in an image, the attended region can usually vary with tasks.

An “attention mechanism” is essentially about applying human perception and attention to machines, and enabling the machines to tell more important parts of information from less important parts. The attention mechanism for deep learning simulates this process. For data input to a neural network, learning is used to identify the key information contents in the input information, so the key information contents can receive more attention or be used in subsequent prediction or reasoning. An attention mechanism may be regarded as a vector of the importance weight in a broader sense. The input embedding vector (embedding) is used to compute how the embedding vector is related to other embedding vectors, and the sum of their values is taken as the approximation to be output.

CN110472068A discloses big-data processing method, equipment and media based on heterogeneous, distributed knowledge graphs. The method includes: according to the data structure of a heterogeneous, distributed knowledge base, constructing a node table and a relation table of heterogeneous, distributed knowledge graphs; according to a graph computing request, identifying a graph computing scenario, so as to determine types and/or attributes of nodes and types and/or attributes of edges required by the graph computing scenario; extracting at least one computing node from the node table and the relation table that correspond to the graph computing scenario; filtering node data of the at least one node from the heterogeneous, distributed knowledge graphs; processing the filtered node data so as to obtain a data processing result based on the heterogeneous, distributed knowledge graphs. The known embodiment provides an efficient way to process data of heterogeneous, distributed knowledge graphs by virtue of the node table and the relation table.

CN112395423A discloses a recursive time sequence knowledge graph completion method and a device, wherein the method comprises the following steps: acquiring a static knowledge graph corresponding to an acquired time sequence knowledge graph, and acquiring updated characteristics of the static knowledge graph and the characteristics through embedded learning; by adopting a recursion mode, taking the sub-knowledge graph of the first time stamp as a starting point, taking the sub-knowledge graph, the characteristics and the embedded learning parameters of the current time stamp as the input of embedded learning to obtain updated embedded learning parameters and characteristics, and taking the updated embedded learning parameters and characteristics as the embedded learning parameters and characteristics of the sub-knowledge graph of the next adjacent time stamp until traversing all the sub-knowledge graph sequences of the time stamps; and performing fact prediction for each of the timestamp sub-knowledge graphs.

CN112364108A discloses a time sequence knowledge graph completion method based on a space-time architecture, which comprises the following steps: dividing a to-be-supplemented time sequence knowledge graph into a plurality of static knowledge sets according to the time labels of the knowledge, and respectively constructing a plurality of knowledge networks through the knowledge in each set to obtain a plurality of snapshots; constructing a multi-face graph attention network, inputting snapshots into the multi-face graph attention network, and acquiring static embedded representation of an entity under each snapshot; constructing an adaptive time sequence attention mechanism, and acquiring a final embedding representation of an entity according to the static embedding representation of the entity by using the adaptive time sequence attention mechanism; and calculating the confidence coefficient of the knowledge in the time sequence knowledge graph to be supplemented through the final embedded representation of the entity, and predicting the missing content in the time sequence knowledge graph to be supplemented through the confidence coefficient.

Some recent studies focused on prediction of future events in temporal knowledge graphs. For example, RE-NET is about modeling the occurrence of facts into historical, conditional probability distribution; CyGNet is about regarding entities appearing on historical timestamps as abstractive summarization of future facts; an HIP network enables prediction by transferring historical information from the perspectives of time, structure, and repetition; xERTE involves generating query subgraphs of a certain hop count by constructing reasoning schemas; CluSTeR and TITer both use reinforcement learning to determine evolution in query paths; and RE-GCN is about learning entity representation including evolution information by modeling a sequence of subgraphs of recent historical timestamps.

However, the aforementioned methods for temporal knowledge graph reasoning are limited to the encoder-decoder structure, and problems raised from the time-varying nature are totally ignored in the process of temporal knowledge graph reasoning. These known methods tend to learn and obtain constant entity embedding representation. Therefore, they not only are unable to capture newly appearing historical information timely, but also compress dynamic evolution of the historical information in a constant low-dimension vector, which leads to incompletion of distributed representation information at different historical timestamp. CEN attempts to address problems raised from the time-varying nature in an online learning setting, but it is still limited to continuous adjustment of a constant representation vector with a limited length, opposite to using a distributed modelling strategy. This will necessarily cause loss of distributed information.

In addition, on one hand, due to the differences in the understanding of those skilled in the art; on the other hand, due to the fact that the applicant studied a large amount of literature and patents when putting the invention, but space limitations do not allow all the details and content are described in detail, however, this does not mean that the invention does not have these prior art features, on the contrary, the present invention already has all the features of the prior art, and the applicant reserves the right to add relevant prior art to the background technology.

### SUMMARY OF THE INVENTION

In response to the deficiencies of the prior solutions, the present invention provides method, system, electronic device and storage medium for temporal knowledge graph reasoning based on distributed attention, aiming to solve at least one or more technical problems existing in the prior art.

To achieve the foregoing objective, the present invention provides a method for temporal knowledge graph reasoning based on distributed attention, comprising the following parts:

Recombining a temporal knowledge graph in a temporal serialization manner, and storing distribution of historical timestamp subgraphs into a sparse matrix, to accurately express structural dependency of a temporal subgraph sequence; Constructing initial first-layer attention from facts of predicted timestamps to the facts

that are historically repeated using an attention mechanism, to capture traditionally constant features in historical information;

Building second-layer attention based on statistics of historical frequency information that evolves with the timestamps, and adjusting a score of the first-layer attention according to updates in knowledge, and assigning attention reward and punishment to historically repeated facts and non-repeated facts, respectively, to deal with time-varying features in historical information.

According to a flexible parameter training strategy, initializing embedded vectors of entities and relations and learnable parameters such as a query transformation matrix and a key transformation matrix, and using a non-learning fold mapping strategy to represent time information, so as to find the optimal model and accomplish reasoning prediction of the temporal knowledge graph.

Preferably, the step of performing temporal serialization to temporal knowledge graph, and storing distribution of historical timestamp subgraphs into a sparse matrix, to accurately express structural dependency of a temporal subgraph sequence comprises:

Partitioning the temporal knowledge graph into a series of knowledge subgraph sequences in a chronological order, so as to dimensionally reduce representation of the temporal knowledge graph from quadruples to triples and facilitating internal time dependency of the temporal knowledge graph.

According to records of the sparse matrix, predicting historical patterns of a to-be-predicted event in similar scenarios over time, and converting time consumption for historical queries into quantified space consumption.

Preferably, the learning process of the step constructing initial first-layer attention of facts of predicted timestamps to the facts that are historically repeated using an attention mechanism, to capture traditionally constant features in historical information comprises:

Performing mask filling on sequences of historically repeated facts corresponding to each of the queries in the same batch in order to process query facts in batches. Specifically, this is done by using a relation-entity pair that has never appeared to fill any of the sequences that is shorter than the longest sequence in the batch, so as to generate a mask matrix using identification marks, and exclude these sequences from an attention operation, thereby significantly reducing computing complexity.

Computing a multi-headed attention from a query matrix Q to a key matrix (K, V) after said mask filling. Specifically, this is about performing a scaled dot-product attention operation, calculating a dot product using the query matrix (Q) and the key matrix (K), dividing the dot product by a scaling factor to obtain a weight matrix; and then calculating a dot product using the weight matrix and a value matrix V so as to obtain a value matrix associated with a representation attention, wherein a vector of every dimension in the value matrix represents an initial distributed attention assigned to each of the historically repeated facts.

Supplementing deep semantic information using a fully connected feedforward neural network that comprises plural hidden units. Additionally, layer normalization and residual connection are performed on outputs from both the multi-headed attention and the feedforward neural network, so as to prevent gradient vanishing during training and accelerate convergence.

Preferably, in the present invention, second-layer attention is constructed based on statistics of historical frequency information varying with the timestamps for adjustment of the score of the first-layer attention, and historically repeated facts and non-repeated facts are assigned with attention reward and punishment, respectively, to address the time-varying features of historical information. This is particularly done by:

Timely superimposing the frequency information statistics in the new historical information, thereby representing updates in knowledge through the change of historical frequency information, and then adjusting the initial intention of the first-layer attention.

Based on the updated statistics of the historical frequency information, assigning an attention punishment to any fact that has never appeared historically, which is specifically about adding a relatively great negative value to the score of the first-layer attention.

Based on the updated statistics of the historical frequency information, assigning an attention reward to each of facts that have appeared historically, which is specifically about inputting the updated frequency to the Softmax function, so as to obtain a positive value between 0 and 1, and add it to the score of the first-layer attention.

Preferably, the present invention provides a system for temporal knowledge graph reasoning based on distributed attention, the method comprising:
a scheduling unit, configured to recombine a temporal knowledge graph in a temporal serialization manner according to an order of timestamps in the temporal knowledge graph, and store distribution of historical timestamp subgraphs into a sparse matrix;
a processing unit, configured to construct facts of predicted timestamps using an attention mechanism and assign initial first-layer attention to the facts that are historically repeated; an adjusting unit, configured to build second-layer attention based on statistics of historical frequency information that evolves with the timestamps, and adjust a score of the first-layer attention according to updates in knowledge; and
a training unit, configured to according to a parameter training strategy, train a model with multi-class tasks based on cross entropy loss.

Preferably, the present invention provides an electronic device, characterized in that it comprises:
one or more processors;
a memory, for storing one or more computer programs;
when the one or more computer programs are executed by the one or more processors, the one or more processors implementing the method for temporal knowledge graph reasoning based on distributed attention.

Preferably, the present invention provides a storage medium comprising computer-executable instructions, characterized in that the computer-executable instructions are used, when executed by a computer processor, to perform the method for temporal knowledge graph reasoning based on distributed attention.

Preferably, in the present invention, a flexible parameter training strategy is used for representation learning. For embedding of time information, non-trained fold mapping relations are used to improve representation efficiency and reduce training time. Vector initialization is performed on the embedding representation for entities and relations, and error control is set to ensure accurate embedding. In addition, learnable parameters like the query transformation matrix, the key transformation matrix, and offset of the linear transformation coefficient have to be initialized. The process of representation learning is innovatively treated as a multi-class task each having a number of classes equal to a size of an entity set of the multi-class task. A cross entropy loss function and an AMSGrad optimizer are used for learning parameters of the multi-class tasks. At last, by observing the prediction performance of a fact on a validation sample, the optimal set of values of parameters for the model is determined, thereby acquiring the optimal model to improve accuracy of temporal reasoning prediction.

Preferably, the present invention relates to a distributed-attention-based temporal knowledge graph reasoning model. It is based on a reasoning model, and can assign attention differently to different historical information according to importance of the historical information in a distributed manner, so that a query can selectively refer to suitable historical information according to different functions of different historical timestamps, so as to achieve more accurate prediction. As compared to prediction models for future events based on the traditional encoder-decoder architecture, the present invention assigns learnable attention in a distributed manner to different historical timestamps instead of obtaining a fixed embedding for simple representation by means of an encode, so the resulting model can solve problems raised from the time-varying nature better.

### BRIEF DESCRIPTION OF THE DRAWINGS

In order to illustrate the embodiments of the present invention or the technical solutions in the prior art more clearly, a brief introduce of the accompanying drawings that need to be used in the description of the embodiments or the prior art will be made below. Obviously, the drawings in the following description are only partial embodiments of the present invention, and for those of ordinary skill in the art, other drawings can also be obtained from these drawings without creative effort.

FIG. 1 is a structural diagram illustrating the principle of a model for temporal knowledge graph reasoning based on distributed attention according to one preferred mode of execution of the present invention;

FIG. 2 is a structural diagram of a system for temporal knowledge graph reasoning based on distributed attention according to one preferred mode of execution of the present invention; and FIG. 3 is a structural diagram illustrating the principle of an electronic device for temporal

knowledge graph reasoning based on distributed attention according to one preferred mode of execution of the present invention.

### DETAILED DESCRIPTION OF THE INVENTION

The present invention will be described in detail below with reference to accompanying drawings.

### Embodiment 1

The present invention provides method and model for temporal knowledge graph

reasoning based on distributed attention, wherein the method comprises the following parts:
recombining a temporal knowledge graph in a temporal serialization manner, and storing distribution of historical timestamp subgraphs into a sparse matrix;
constructing initial first-layer attention of facts of predicted timestamps to the facts that are historically repeated using an attention mechanism, to capture traditionally constant features in historical information;
assigning, by the query fact, initial first-layer attention to the facts that are historically repeated using an attention mechanism;
building second-layer attention based on the change of statistics of historical frequency information, and adjusting a score of the first-layer attention according to updates in knowledge; and
according to a parameter training strategy, training a model with multi-class tasks based on cross entropy loss.

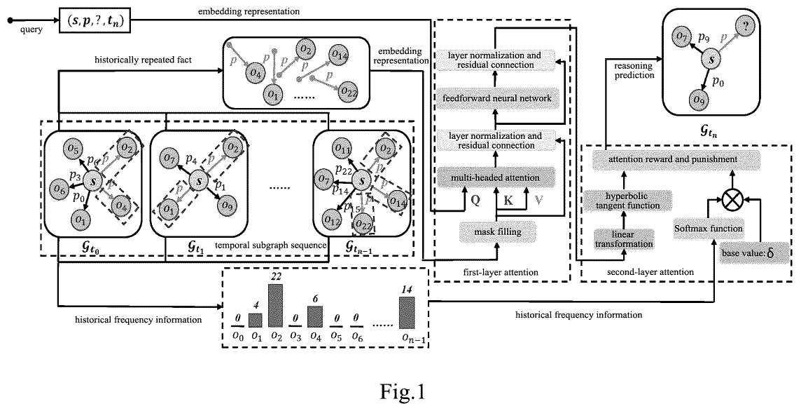

According to a preferred mode, as shown in FIG. 1, recombining a temporal knowledge graph in a temporal serialization manner can be specifically achieved as below. A temporal knowledge graph [symbol] , which contains an entity set ϵ having a size of N, a relation set [symbol] having a size of P, and a timestamp set [symbol] having a size of T, is partitioned into a sequence of temporal subgraphs [symbol] ={ [symbol] ₀, [symbol] ₁, . . . , [symbol] _{T-1}} in the order of timestamps. Therein, every subgraph is a complete, static knowledge graph. For a query fact (s, p, o, tₙ), the temporal knowledge graph reasoning task may be understood as completing an incomplete fact (s, p, ?, tₙ) or (?, p, o, tₙ) based on the historical subgraph sequence { [symbol] ₜ|t<tₙ}, where ? represents a lost object entity or a lost subject entity, respectively.

Further, storing distribution of historical timestamp subgraphs into a sparse matrix can be specifically achieved as below. The matrix is sized as two-dimensional N*P×N for respectively recording information of repeated or non-repeated distribution of every query fact on every historical timestamp. Since an individual fact only has a specific time range and can only happen once in a single timestamp, the distribution matrix of every timestamp is actually a sparse matrix having only a few 1s and a lot of 0s. Storage using a sparse matrix significantly increases space usage.

Specifically, three one-dimension vectors may be used to represent a high dimension matrix, including a value vector for recording values of the non-zero elements in the two-dimensional matrix; an abscissa vector for recording abscissa locations of the non-zero elements in the two-dimensional matrix successively; and an ordinate vector for recording ordinate locations of the non-zero elements in the two-dimensional matrix successively. Thereby, if (s, p, o) has appeared at the t^{th} historical timestamp, in the t^{th} sparse matrix, the element corresponding to an abscissa of s*p and an ordinate of o will be represented by 1; otherwise by 0. Based on the sparse matrix, historically repeated facts (s, p, o₀, t₀), . . . , (s, p, o ᵢ, tᵢ), . . . , (s, p, oₙ₋₁, tₙ₋₁) and historical frequency information Mₜ_{ₙ}^{(s,p)} can be extracted, where Mₜ_{ₙ}^{(s,p)} is an N-dimension vector, wherein its every dimension represents the frequency the corresponding entity appeared historically, {tᵢ|0≤i≤n−1} represents the entire historical timestamp set of the currently queried timestamp tₙ, and {oᵢ} represents a historical repeated entity set.

According to a preferred mode of execution, as shown in FIG. 1, the step of constructing facts of predicted timestamps using an attention mechanism and assigning initial first-layer attention to the facts that are historically repeated can be specifically done as below. For a query (s, p, ?, tₙ), s, p, oᵢ and tₙ are represented as embedding representations of the corresponding query entity, historically repeated entity, the relation, and the timestamp. Then with Q=W_{q}[s, p], a query matrix Q is generated, and with K=Wₖ[p, oᵢ] and V=Wᵥ[p, oᵢ], key matrixes K and V are generated, where W_{q}, Wₖ and Wᵥ are all coefficient matrixes.

Further, based on the attention mechanism, the query fact assigns learnable first-layer initial attention to a historically repeated fact, represented as:

$$Self\_Attention ( Q , K , V ) = softmax ( \frac{{W}_{q} [ s , p ] {( {W}_{k} [ p , {o}_{i} ] )}^{T}}{\sqrt{{d}_{k}}} ) {W}_{v} [ p , {o}_{i} ] ,$$

where dₖ is the scaling factor. For preventing the Softmax function from the vanishing gradient problem, multi-headed attention is about assigning multiple learnable W_{q}, Wₖ and Wᵥ parameter matrixes to operation on the basis of self-attention, so that the model can learn multiple semantic effects from the perspectives of multiple sub-spaces. The feedforward neural network uses a fully connected network FFN(x)=W₁(RELU(W₂x)) having a hidden layer of 2048, where X is the output of multi-headed attention, W₁ and W₂ are coefficient matrixes, and the activation function used is RELU.

Particularly, the outputs of both multi-headed attention and the feedforward neural network are processed by means of layer normalization and residual connection, so as to speed up convergence. Specifically, layer normalization is about scaling the vector content to a value between 0 and 1, and the residual connection is about summing up contents of the input and output vectors of the network, so as to preserve certain input features.

According to a preferred mode of execution, as shown in FIG. 1, the step of building second-layer attention based on statistics of historical frequency information that evolves with the timestamps, and adjusting a score of the first-layer attention according to updates in knowledge can specifically as described below. Assuming that the output vector of the first-layer attention is y, it is first subjected to linear transformation and then input to the hyperbolic tangent function, so the score of the first-layer attention is regulated within the range between −1 and 1, sₜ=tanh(Wₜ[y, tₙ]+bₜ), so the score interval is 2.

Then, the second-layer attention according to the latest update of the historical frequency information imposes attention punishment to any fact that has never appeared. Specifically, this is done by adding a relatively great negative value to its score, defined as [symbol] ₜ_{ₙ}^{(s,p)}. For a fact that have appeared in the history, attention reward is given according to the latest update of the statistics of its historical frequency information (denoted by [symbol] ₜ_{ₙ}^{(s,p)}). Specifically, this is done by assigning a positive value [symbol] ₜ_{ₙ}^{(s,p)}=softmax ( [symbol] ₜ_{ₙ}^{(s,p)})*δ thereto on the basis of its first-layer attention score according to its frequency information statistics. Therein, the base value δ is set as 2, which is the output score range of the first-layer attention, thereby the two attention layers can both function. Then the final reasoning prediction score may be represented as s=softmax(sₜ+ [symbol] ₜ_{ₙ}^{(s,p)}+ [symbol] ₜ_{ₙ}^{(s,p)}).

According to a preferred mode of execution, as shown in FIG. 1, according to a flexible parameter training strategy, training a model with multi-class tasks based on cross entropy loss can be specifically achieved as below. The model performs embedding representation on ordered temporal information in the manner of nonparametric multiple mapping. For example, for {2014/1/1, 2014/1/2, . . . , 2014/12/30, 2014/12/31}, the embedding vector of the first timestamp 2014/1/1 is first randomly initialized as e, and then the low-dimension vector embedding of the time series obtained through nonparametric multiple mapping may be represented as T={e, 2e, 3e, 4e, . . . , Te}, where T is the number of timestamps that can get through partitioning in certain scenarios. Then the time embedding T does not participate in training for the model, thereby directly endowing the temporal information with order dependency. This not only reduces computing complexity for the model, but also facilitates temporal information modeling of the knowledge graph.

Particularly, cross-entropy represents two kinds of probability distribution p, q, wherein

p represents a true distribution, and q represents a non-true distribution in the same set of events. Therein, the non-true distribution q is used to represent the average number of bits required for some event to happen. Cross-entropy is typically used as a loss function for multi-class problems, and is usually taken as measurement of distance between the prediction value and the true label value.

Further, reasoning-based completion of the temporal knowledge graph is regarded as a multi-class task. A multi-class task is a classification learning task involving more than two classes. For example, for a query (s, p, ?, tₙ), a proper entity is selected from the candidate entity set to answer (complete) the missing object entity. The number of classes is the size of the entity set, N, and the final prediction score is multi-hot vector sized N in dimension. The model will select the fact having the highest score among the vectors as the result of future event prediction: o=argmax_{o∈ϵ}(p(o|s, p, tₙ)). The cross entropy loss function used for multi-class tasks may be denoted as [symbol] =− [symbol] Σ_{i∈ϵ}Σ_{j∈ϵ}oᵢ^{t}lnp(yᵢ^{j}|s, p, tₙ), where oᵢ^{t} represents the l^{th} baseline entity (i.e. the correct result of prediction) in the t^{th} temporal subgraph Gₜ, and p(yᵢ^{j}|s, p, tₙ) is represented as oᵢ^{t}, which is the probability of the j^{th} (the entity numbered as j) in the entity set ϵ. Subsequently, the global loss function is reduced on the validation sample until the proper parameter corresponding to the optimal model is found.

### Embodiment 2

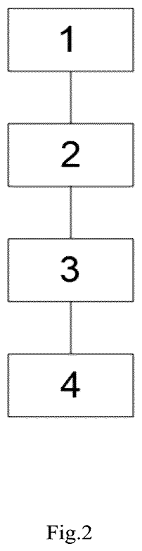

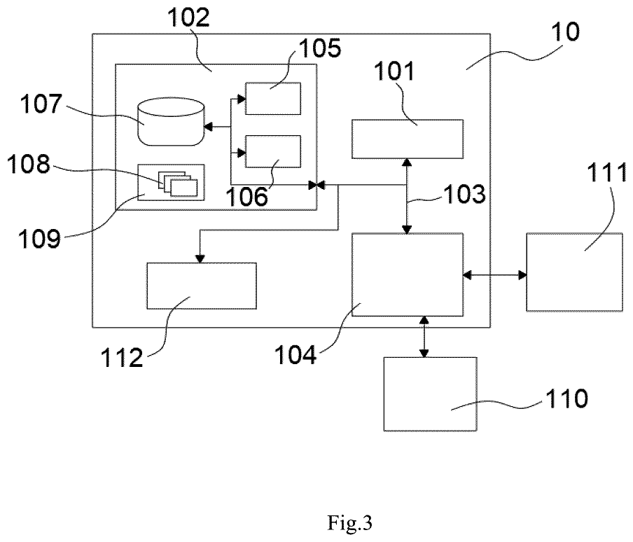

As shown in FIG. 2, bases on the above disclosed method for temporal knowledge graph reasoning based on distributed attention, the present invention provides a system for temporal knowledge graph reasoning based on distributed attention.

Specifically, the system for temporal knowledge graph reasoning based on distributed attention in the present invention can comprise:
a scheduling unit 1, configured to recombine a temporal knowledge graph in a temporal serialization manner, and store distribution of historical timestamp subgraphs into a sparse matrix;
a processing unit 2, configured to assign, by the query fact, initial first-layer attention to the facts that are historically repeated using an attention mechanism;
an adjusting unit 3, configured to build second-layer attention based on statistics of historical frequency information that evolves with the timestamps, and adjust a score of the first-layer attention according to updates in knowledge; and
a training unit 4, configured to according to a parameter training strategy, train a model with multi-class tasks based on cross entropy loss.

According to a preferred mode of execution, in this embodiment, the scheduling unit 1 is configured to perform the following steps. A temporal knowledge graph [symbol] , which contains an entity set ϵ having a size of N, a relation set [symbol] having a size of P, and a timestamp set [symbol] having a size of T, is partitioned into a sequence of temporal subgraphs [symbol] ={ [symbol] ₀, [symbol] ₁, . . . , [symbol] _{T-1}} in the order of timestamps. Therein, every subgraph is a complete, static knowledge graph. For a query fact (s, p, o, tₙ), the temporal knowledge graph reasoning task may be understood as completing an incomplete fact (s, p, ?, tₙ) or (?, p, o, tₙ) based on the historical subgraph sequence { [symbol] ₜ|t<tₙ}, where ? represents a lost object entity or a lost subject entity, respectively.

Further, storing, by the scheduling unit 1, distribution of historical timestamp subgraphs into a sparse matrix can be specifically achieved as below. The matrix is sized as two-dimensional N*P×N for respectively recording information of repeated or non-repeated distribution of every query fact on every historical timestamp. Since an individual fact only has a specific time range and can only happen once in a single timestamp, the distribution matrix of every timestamp is actually a sparse matrix having only a few 1s and a lot of 0s. Storage using a sparse matrix significantly increases space usage.

Specifically, three one-dimension vectors may be used to represent a high dimension matrix, including a value vector for recording values of the non-zero elements in the two-dimensional matrix; an abscissa vector for recording abscissa locations of the non-zero elements in the two-dimensional matrix successively; and an ordinate vector for recording ordinate locations of the non-zero elements in the two-dimensional matrix successively. Thereby, if (s, p, o) has appeared at the t^{th} historical timestamp, in the t^{th} sparse matrix, the element corresponding to an abscissa of s*p and an ordinate of o will be represented by 1; otherwise by 0. Based on the sparse matrix, historically repeated facts {(s, p, o₀, t₀), . . . , (s, p, oᵢ,tᵢ), . . . ,(s, p, oₙ₋₁, tₙ₋₁)} and historical frequency information Mₜ_{ₙ}^{(s,p)} can be extracted, where Mₜ_{ₙ}^{(s,p)} is an N-dimension vector, wherein its every dimension represents the frequency the corresponding entity appeared historically, {tᵢ|0≤i≤n−1} represents the entire historical timestamp set of the currently queried timestamp tₙ, and {oᵢ} represents a historical repeated entity set.

According to a preferred mode of execution, in this embodiment, the processing unit 2 is configured to perform the following steps: assigning, by the query fact, initial first-layer attention to the facts that are historically repeated using an attention mechanism. Specifically, for a query (s, p, ?, tₙ), s, p, oᵢ and tₙ are represented as embedding representations of the corresponding query entity, historically repeated entity, the relation, and the timestamp. Then with Q=W_{q}[s, p], a query matrix Q is generated, and with K=Wₖ[p, oᵢ] and V=Wᵥ[p, oᵢ], key matrixes K and V are generated, where W_{q}, Wₖ and Wᵥ are all coefficient matrixes.

Further, based on the attention mechanism, the processing unit 2 is configured to make the query fact assign learnable first-layer initial attention to a historically repeated fact, represented as:

$$Self\_Attention ( Q , K , V ) = softmax ( \frac{{W}_{q} [ s , p ] {( {W}_{k} [ p , {o}_{i} ] )}^{T}}{\sqrt{{d}_{k}}} ) {W}_{v} [ p , {o}_{i} ] ,$$

where dₖ is the scaling factor. For preventing the Softmax function from the vanishing gradient problem, multi-headed attention is about assigning multiple learnable W_{q}, Wₖ and Wᵥ parameter matrixes to operation on the basis of self-attention, so that the model can learn multiple semantic effects from the perspectives of multiple sub-spaces. The feedforward neural network uses a fully connected network FFN(x)=W₁(RELU(W₂x)) having a hidden layer of 2048, where X is the output of multi-headed attention, W₁ and W₂ are coefficient matrixes, and the activation function used is RELU. Specifically, the outputs of both multi-headed attention and the feedforward neural network are processed by means of layer normalization and residual connection, so as to speed up convergence. Specifically, layer normalization is about scaling the vector content to a value between 0 and 1, and the residual connection is about summing up contents of the input and output vectors of the network, so as to preserve certain input features.

According to a preferred mode of execution, in this embodiment, the adjusting unit 3 is configured to perform the following steps: building second-layer attention based on statistics of historical frequency information that evolves with the timestamps, and adjusting a score of the first-layer attention according to updates in knowledge, which can be specifically achieved as below. Assuming that the output vector of the first-layer attention is y, it is first subjected to linear transformation and then input to the hyperbolic tangent function, so the score of the first-layer attention is regulated within the range between −1 and 1, sₜ=tanh(Wₜ[y, tₙ]+bₜ), so the score interval is 2. Then, the second-layer attention according to the latest update of the historical frequency information imposes attention punishment to any fact that has never appeared. Specifically, this is done by adding a relatively great negative value to its score, defined as [symbol] ₜ_{ₙ}^{(s,p)}. For a fact that have appeared in the history, attention reward is given according to the latest update of the statistics of its historical frequency information (denoted by [symbol] ₜ_{ₙ}^{(s,p)}. Specifically, this is done by assigning a positive value [symbol] ₜ_{ₙ}^{(s,p)}=softmax( [symbol] ₜ_{ₙ}^{(s,p)}*δ thereto on the basis of its first-layer attention score according to its frequency information statistics. Therein, the base value δ is set as 2, which is the output score range of the first-layer attention, thereby the two attention layers can both function. Then the final reasoning prediction score may be represented as s=softmax(sₜ+ [symbol] ₜ_{ₙ}^{(s,p)}+ [symbol] ₜ_{ₙ}^{(s,p)}).

According to a preferred mode of execution, in this embodiment, a training unit 4 is configured to perform the following steps: according to a flexible parameter training strategy, training a model with multi-class tasks based on cross entropy loss, which can be specifically achieved as below. The model performs embedding representation on ordered temporal information in the manner of nonparametric multiple mapping. For example, for {2014/1/1, 2014/1/2, . . . , 2014/12/30, 2014/12/31}, the embedding vector of the first timestamp 2014/1/1 is first randomly initialized as e, and then the low-dimension vector embedding of the time series obtained through nonparametric multiple mapping may be represented as T={e, 2e, 3e, 4e, . . . , Te}, where T is the number of timestamps that can get through partitioning in certain scenarios. Then the time embedding T does not participate in training for the model, thereby directly endowing the temporal information with order dependency. This not only reduces computing complexity for the model, but also facilitates temporal information modeling of the knowledge graph.

Particularly, cross-entropy represents two kinds of probability distribution p, q, wherein p represents a true distribution, and q represents a non-true distribution in the same set of events. Therein, the non-true distribution q is used to represent the average number of bits required for some event to happen. Cross-entropy is typically used as a loss function for multi-class problems, and is usually taken as measurement of distance between the prediction value and the true label value.

Further, reasoning-based completion of the temporal knowledge graph is regarded as a

multi-class task. A multi-class task is a classification learning task involving more than two classes. For example, for a query (s, p, ?, tₙ), a proper entity is selected from the candidate entity set to answer (complete) the missing object entity. The number of classes is the size of the entity set, N, and the final prediction score is multi-hot vector sized N in dimension. The model will select the fact having the highest score among the vectors as the result of future event prediction: o=argmax_{o∈ϵ}(p(o|s, p, tₙ)). The cross entropy loss function used for multi-class tasks may be denoted as [symbol] =− [symbol] Σ_{i∈ϵ}Σ_{j∈ϵ}oᵢ^{t}lnp(yᵢ^{j}|s, p, tₙ), where of represents the l^{th} baseline entity (i.e. the correct result of prediction) in the t^{th} temporal subgraph Gₜ, and p(yᵢ^{j}|s, p, tₙ) is represented as oᵢ^{t}, which is the probability of the j^{th} (the entity numbered as j) in the entity set ϵ. Subsequently, the global loss function is reduced on the validation sample until the proper parameter corresponding to the optimal model is found.

It should be understood that, the number and functions of the modules in this embodiment are only for the convenience of description, and should not be regarded as any limitation on the functions and scope of use of the embodiments of the present invention. In some other optional manners, a larger number of modules or units may be set according to specific subdivision steps, so as to implement various functions and/or methods described in this embodiment.

### Embodiment 3

FIG. 3 shows an electronic device 10 for implementing the method for temporal knowledge graph reasoning based on distributed attention described in Embodiment 1 above. The electronic device 10 shown in FIG. 3 is only an example, and should not impose any limitations on the function and scope of use of the embodiments of the present invention.

Specifically, as shown in FIG. 3, the electronic device 10 is represented in the form of a general-purpose computer device, and the electronic device can comprise: one or more processors 101;
a memory 102, for storing one or more computer programs;
communication bus 103, used to connect different system components (including the processor 101 and the memory 102).

According to a preferred mode of execution, the processor 101 executes the functions and/or methods described in the embodiments of the present invention by running one or more computer programs stored in the memory 102, and in particular, implements the method for temporal knowledge graph reasoning based on distributed attention described in the present invention.

According to a preferred mode of execution, electronic device 10 may include a variety of computer system readable media. These media can be any available media that can be accessed by electronic device 10, including both volatile and non-volatile media, removable and non-removable media.

According to a preferred mode of execution, the processor 101 includes, but is not limited to, a CPU (Central Processing Unit), an MPU (Micro Processor Unit), an MCU (Micro Control Unit), an SOC (System on Chip), and the like.

According to a preferred mode of execution, memory 102 includes, but is not limited to, computer system readable media in the form of volatile memory, or other removable/non-removable and non-volatile computer system storage media. Specifically, as shown in FIG. 3, the memory 102 is, for example, a random access memory (RAM) 105 and/or a cache memory 106.

According to a preferred mode of execution, the communication bus 103 represents one or more of several types of bus structures, including a memory bus or memory controller, a peripheral bus, a graphics acceleration port, a processor, or a local bus using any bus structure of a variety of bus structures. Specifically, these architectures include, but are not limited to, the Industry Standard Architecture (ISA) bus, the Microchannel Architecture (MAC) bus, the Enhanced ISA bus, the Video Electronics Standards Association (VESA) local bus, and the Peripheral Component Interconnect (PCI) bus.

According to a preferred mode of execution, the storage section 107 may be used to read and write non-removable, non-volatile magnetic media. Further, magnetic drivers for reading and writing removable non-volatile magnetic disks (e.g., floppy disks) and disc drivers for reading and writing removable non-volatile optical disks (e.g., CD-ROM, DVD-ROM or other optical media) may be provided. Each drive may be connected to communication bus 103 through one or more data media interfaces.

According to a preferred mode of execution, the memory 102 may include at least one program product. The program product has at least one set of program modules 108 or at least one utility 109. These program modules 108 may be configured in the memory 102 to perform the functions and/or methods described in various embodiments of the present invention.

According to a preferred mode of execution, the electronic device 10 can communicate with at least one external device 110 (e.g., keyboard, display 111, etc.), or any device that enables the electronic device 70 to communicate with at least one other computing device, through the communication interface 104 (e.g., network card, modem, etc.) communication connection.

According to a preferred mode of execution, the electronic device 10 may communicate with one or more networks (e.g., a local area network (LAN), a wide area network (WAN), and/or a public network such as the Internet) through a network adapter 112.

According to a preferred mode of execution, the network adapter 112 communicates with other modules of the electronic device 10 via the communication bus 103. It should be understood that, although not shown in FIG. 3, other hardware and/or software modules may be used in conjunction with electronic device 10, including but not limited to microcode, device drivers, redundant processing units, external disk drive arrays, RAID systems, Tape drives and data backup storage systems, etc.

### Embodiment 4

The present invention also provides a storage medium containing computer-executable instructions, the computer-executable instructions are used to, when executed by a computer processor, execute the method for temporal knowledge graph reasoning based on distributed attention described in the present invention.

According to a preferred mode of execution, the computer storage medium of Embodiment 4 of the present invention may adopt any combination of one or more computer-readable media. The computer-readable medium may be a computer-readable signal medium or a computer-readable storage medium. Computer readable storage media include, but are not limited to, electrical, magnetic, optical, electromagnetic, infrared, or semiconductor systems, apparatus or devices, or any combination of the above.

According to a preferred mode of execution, more specific examples of computer-readable storage media include: electrical connections with one or more wires, portable computer disks, hard disks, random access memory (RAM), read only memory (ROM), Erasable Programmable Read Only Memory (EPROM or Flash), fiber optics, portable compact disk read only memory (CD-ROM), optical storage devices, magnetic storage devices, or any suitable combination of the above. In the present invention, a computer-readable storage medium may be any tangible medium that contains or stores a program that can be used by or in conjunction with an instruction execution system, apparatus, or device.

According to a preferred mode of execution, a computer-readable signal medium may include a data signal propagated in baseband or as part of a carrier wave, carrying computer-readable program code therein. Such propagated data signals may take a variety of forms, including but not limited to electromagnetic signals, optical signals, or any suitable combination of the foregoing. A computer-readable signal medium can also be any computer-readable medium other than a computer-readable storage medium that can transmit, propagate, or transport the program for use by or in connection with the instruction execution system, apparatus, or device.

According to a preferred mode of execution, program code embodied on a computer readable medium may be transmitted using any suitable medium, including but not limited to wireless, wire, optical fiber cable or RF, etc., or any suitable combination of the foregoing.

According to a preferred mode of execution, computer program code for carrying out the operations of embodiments of the present invention may be written in one or more programming languages, including object-oriented programming languages, such as python, or a combination thereof, Java, Smalltalk, C++, and also conventional procedural programming languages, such as the “C” language or similar programming languages. The program code may execute entirely on the user's computer, partly on the user's computer, as a stand-alone software package, partly on the user's computer and partly on a remote computer, or entirely on the remote computer or server. Where a remote computer is involved, the remote computer may be connected to the user's computer through any kind of network, including a local area network (LAN) or wide area network (WAN), or may be connected to an external computer (e.g., using an Internet service provider to connect through the Internet)).

For explaining the technical scheme clearly, one mode of execution of the method for temporal knowledge graph reasoning based on distributed attention according to one embodiment of the present invention is described below with respect to a specific application. In the real world, some events can repeatedly appear throughout the history. If determination is to be made for a query of “what disease was Resident Someone diagnosed with in March 2022?” the first thing to do is to make extraction from historical information. Herein, for example, the resident was diagnosed with COVID-19 pneumonia in May 2020 and had complications such as coughing and diarrhea and not cured due to medical immaturity. Then in December 2020, he was diagnosed with sepsis as a serious complication, and also had coughing and other conditions. At this time point, with more mature medical development for treating COVID-19 pneumonia, the conditions of the resident got improvement. Later, in October 2021, he was only diagnosed with mild conditions including coughing. The historically repeated facts to be extracted can be mainly represented as {COVID-19 pneumonia, sepsis, coughing} . In the historical frequency information, before the conditions of the resident got improvement (i.e., October 2021), COVID-19 pneumonia and coughing had similar frequencies that are both higher than the frequency of sepsis. It is noted that repeated facts act differently over time, and this gives the possibility that thereby different answers may be received when a query is made toward different timestamps. The time-varying nature means that a query may have a bias on historical information (or effects of historical information of different timestamps on the query) that varies dynamically over time. For the query (a given resident, diagnosed with, ?, March 2022), the first-layer attention first assigns an initial attention to embedding of a historically repeated fact {COVID-19 pneumonia, sepsis, coughing} through embedding of the entity of the resident based on the attention mechanism, this layer of attention learns from relatively farther historical information without considering differences among historical timestamps. This is for capturing constant historical features. For example, if the resident had been diagnosed with both COVID-19 pneumonia and coughing for a long period of time, the two conditions have complication relation therebetween. The second-layer attention adjusts the first-layer attention based on the latest change in the historical frequency information so as to capture time-varying features, for example, the change of attention bias on historically repeated facts for the same query due to the improved medical level. Specifically, since October 2021, the frequency of the mild condition, coughing, has become gradually higher than the frequency of COVID-19 pneumonia and significantly higher than the frequency of sepsis. Therefore, based on the changed frequency statistics, certain attention reward is given to the entity of coughing to amplify its effect on the prediction for March 2022. If an entity has never appeared in the history, it means that the condition has not been found among residents for long. To such an entity, certain attention punishment is imposed to exclude it from the final prediction. Thus, by modeling constant and time-varying historical features, the query “what disease was the resident diagnosed with in March 2022?” can be answered through prediction based on the entity “coughing”.

The reasoning method of the present invention performs temporal serialization on temporal knowledge graphs, and discovers valuable information based on the modeling of historical subgraphs to predict and make decisions on future events, which has extremely high practical value. The chip or processor carrying the temporal knowledge graph reasoning method of the present invention can be installed in equipment in various scenarios such as stock prediction, transaction fraud prediction, disease pathological analysis, financial early warning, and earthquake prediction. In the above practical application scenarios for predictive analysis of diagnosed diseases, the historical invariant features captured by the first layer of attention and the historical time-varying features captured by the second layer of attention play an important role at the same time. For another example, in the scenario of transaction fraud prediction, when the data to be modeled are transaction fraud cases in history, this method will highlight the invariant features of historical fraud cases learned and captured by the first layer of attention; However, in the scenario of financial early warning, when the data to be modeled is a wide range of financial data within a certain time range, such as a financial period that includes both normal financial periods and abnormal trends (such as economic crises), then this method will highlight the time-varying features in the wide range of historical financial data learned by the second-layer of attention, and will capture anomalous trends in the economy and provide early warning of future financial conditions.

The processor equipped with the method of the present invention will process the existing available data in different time ranges in a wide range of scenarios, and then serialize the time series data according to the corresponding timestamps covered by the valid time range. For example, Ban Ki-moon serves as the Secretary-General of the United Nations from 2007 to 2016. If the timestamp granularity is set to year, then the fact (Ban Ki-moon, Secretary-General, United Nations) will be valid on all timestamp sequence subgraphs from 2007 to 2016, and based on this, a future query with an agreed timestamp can be predicted. It should be noted that the predicted future timestamp needs to have the same time granularity as the modeling data, i.e., they should both be year, month, or day. In addition, from the point of view of time variance, with the development of time, the newly generated data of this particular scene will also be incorporated into the data set in time, so that the second layer of attention of the inventive method can timely make adjustment to the prediction results according to the development trend of recent events. The collection equipment of serialized data varies according to the application scenarios. Taking the smart medical scenario as an example, the hospital establishes a health file for each patient through medical records. The file explicitly contains time information, such as (person A, confirmed, Covid-19, Dec. 24, 2020), and then the hospital builds serialized time-series knowledge graphs with different timestamp granularities centered on patients locally or in a cloud (memory type), and the central processing unit (CPU) device of the hospital or cloud can access data from the local or cloud data warehouse through the DMA (Direct Memory Access) controller and call the overall time-serialized historical fact data or the time-serialized historical subgraph fact data centered at person A into memory, and organize then into a matrix/tensor according to batches, which are then copied to the temporarily allocated page-locked memory, after this, the data are copied from the page-locked memory to the GPU video memory through the DMA method again through the PCI-e interface of the graphic processing unit (GPU) device, and then used as the input of the method of the present invention.

For the query (s, p, ?, tₙ), the number of classifications is the predefined entity set size N,

and the final prediction score is a multi-hotspot vector with dimension N, and the model will select the fact with the highest score in the vector as the result of future event prediction. For example, for the fact query (allergy, common medicine, ?, 1960), according to discovery of the first layer of attention in the invention method in historical invariant information before 1960, the completion entity at this time should be the first-generation antihistamine drug “chlorpheniramine”; but with the development of medical technology, in 1988, the second-generation antihistamine drug “Claritin” was successfully launched, at this time, for similar fact query (allergy, common medicine, ?, 2022), the second layer of attention in the invention method will be dedicated to capturing the time-varying information in the history before 2022 (for example, the frequency of use of the drug “Claritin” has risen sharply in the short-term history), then the commonly used drug for allergic diseases will be completed and answered as “Claritin” at this time. It should be noted that, in the processor chip equipped with the method of the present invention, all entities, relationships and timestamps are involved in the calculation in the form of digital codes, such as setting entities “allergies”, “chlorpheniramine”, “Claritin” sequence as codes 0, 1, and 2 in the processor in sequence; the codes corresponding to the relationship “commonly used drugs” are 4; and the codes corresponding to timestamps 1960 and 2022 are 220 and 282. Then, with the codes as a bridge, the numbers corresponding to entities, relationships and timestamps can participate in operations in the processor and learn appropriate embedding expressions. The final output result of the processor chip equipped with the method of the present invention is a multi-hotspot vector with a dimension N corresponding to the query facts of a batch. Taking one of the query facts (allergy, common medicine, ?, 2022) as an example, the entity with the highest score in the corresponding multi-hotspot vector (“Claritin”, the corresponding code is “2”) will be recommended as the answer to the query, and this simple score sorting and filtering is recommended to be assigned to a common central processing unit (CPU) (GPU is not good at it). Therefore, on one hand, the processed multi-hotspot vector needs to be sent to the CPU memory via the PCI-e interface through the page-locked memory in the video memory for the sorting operation of the entity score, and then the output encoding “2” is processed through the onboard entity-encoding comparison table and remapped to an entity name with realistic semantics “Claritin”; on the other hand, the method of the present invention plays a role in assisting decision-making in important fields, such as in the medical field, the final decision-making subject is still the medical staff. The inventive method can choose to return the top-ranked entities as the result. For example, for the query fact (allergy, common medicine, ?, 2022), the returned result after the ranking can be expressed as “Claritin, Chlorpheniramine, Loratadine . . . ”, which contains complicated sematic relations including “first-choice medicine”, “second generation medicine”, “second choice medicine”. Therefore, in real application scenarios, in order to help decision makers in specific scenarios to increase the comprehensibility, after sorting and mapping of reality semantics, multiple returned result facts can be put in hardware loaded with front-end framework applications such as echarts for graph data visualization and further enhance the interpretability of decisions.

For an event prediction query (s, p, ?, tₙ), after the data is processed by the main matrix of the graphics processing unit (GPU) device, the score multi-hotspot vector of size N is output through the PCI-e hardware interface (N is the pre-defined entity set size), and is copied to memory of the central processing unit (CPU) to sort the scores and map the entity names, and finally several prediction results of the query facts are organized into an association graph, graph visualization is then performed based on front-end framework such as echarts (optional), and then the prediction results are sent to the monitor for display via interfaces including VGA, DVI, HDMI and the like.

It should be noted that the above-mentioned specific embodiments are exemplary, and those skilled in the art can come up with various solutions inspired by the disclosure of the present invention, and those solutions also fall within the disclosure scope as well as the protection scope of the present invention. It should be understood by those skilled in the art that the description of the present invention and the accompanying drawings are illustrative rather than limiting to the claims. The protection scope of the present invention is defined by the claims and their equivalents. The description of the present invention contains a number of inventive concepts, such as “preferably”, “according to a preferred embodiment” or “optionally”, and they all indicate that the corresponding paragraph discloses an independent idea, and the applicant reserves the right to file a divisional application based on each of the inventive concepts.

1. A method for temporal knowledge graph reasoning based on distributed attention, the method comprising:
recombining a temporal knowledge graph in a temporal serialization manner according to an order of timestamps in the temporal knowledge graph, and storing distribution of historical timestamp subgraphs into a sparse matrix;
constructing facts of predicted timestamps using an attention mechanism and assigning initial first-layer attention to the facts that are historically repeated;
building second-layer attention based on statistics of historical frequency information that evolves with the timestamps, and adjusting a score of the first-layer attention according to updates in knowledge; and
according to a parameter training strategy, training a model with multi-class tasks based on cross entropy loss.

2. The method of claim 1, wherein the step of recombining a temporal knowledge graph in a temporal serialization manner according to an order of timestamps in the temporal knowledge graph, and storing distribution of historical timestamp subgraphs into a sparse matrix comprises:
partitioning the temporal knowledge graph into a series of knowledge subgraph sequences in a chronological order, so as to dimensionally reduce representation of the temporal knowledge graph from quadruples to triples; and
according to records of the sparse matrix, predicting historical patterns of a to-be-predicted event in similar scenarios over time, and converting time consumption for historical queries into quantified space consumption.

3. The method of claim 2, wherein the step of constructing facts of predicted timestamps using an attention mechanism and assigning initial first-layer attention to the facts that are historically repeated comprises:
performing mask filling on sequences of historically repeated facts corresponding to each of the queries in the same batch;
computing a multi-headed attention from a query matrix Q to a key matrix after said mask filling;
supplementing deep semantic information using a fully connected feedforward neural network that comprises plural hidden units; and
performing layer normalization and residual connection on outputs from both the multi-headed attention and the feedforward neural network.

4. The method of claim 3, wherein the step of building second-layer attention based on statistics of historical frequency information that evolves with the timestamps, and adjusting a score of the first-layer attention according to updates in knowledge comprises:
superimposing frequency information statistics contained in new historical information;
representing the updates in knowledge according to updates in the historical frequency information, so as to adjust the initial first-layer attention;
based on the updated statistics of the historical frequency information, assigning an attention punishment to any fact that has never appeared historically; and
based on the updated statistics of the historical frequency information, assigning an attention reward to each of facts that have appeared historically.

5. The method of claim 4, wherein the step of according to a parameter training strategy, training a model with multi-class tasks based on cross entropy loss comprises:
initializing one or more learnable parameters of a query transformation matrix, a key transformation matrix, and a linear transformation coefficient offset;
treating reasoning-based completion of the temporal knowledge graph as the multi-class tasks each having a number of classes equal to a size of an entity set of the multi-class task;
using a cross entropy loss function and an AMSGrad optimizer to learn parameters of the multi-class tasks so as to identify the fact having the highest score and make said fact as a result of future event prediction.

6. The method of claim 5, wherein the step of performing mask filling on sequences of historically repeated facts corresponding to each of the queries in the same batch comprises:
using a relation-entity pair that has never appeared to fill any of the sequences that is shorter than the longest sequence in the batch, so as to generate a mask matrix using identification marks, and exclude these sequences from an attention operation.

7. The method of claim 6, wherein the step of computing a multi-headed attention from a query matrix Q to a key matrix after said mask filling comprises:
performing a scaled dot-product attention operation, calculating a dot product using the query matrix Q and the key matrix K, and dividing the dot product by a scaling factor to obtain a weight matrix; and
calculating a dot product using the weight matrix and a value matrix V so as to obtain a value matrix associated with a representation attention, wherein a vector of every dimension in the value matrix represents an initial distributed attention assigned to each of the historically repeated facts.

8. The method of claim 7, wherein recombining a temporal knowledge graph in a temporal serialization manner can be specifically achieved as:
a temporal knowledge graph g, which contains an entity set E having a size of N, a relation set [symbol] having a size of P, and a timestamp set [symbol] having a size of T, is partitioned into a sequence of temporal subgraphs [symbol] ={ [symbol] ₀, [symbol] ₁, . . . , [symbol] _{T-1}} in the order of timestamps, every subgraph is a complete, static knowledge graph, for a query fact (s, p, o, tₙ), the temporal knowledge graph reasoning task is understood as completing an incomplete fact (s, p, ?, tₙ) or (?, p, o, tₙ) based on the historical subgraph sequence { [symbol] ₜ|t<tₙ}, where ? represents a lost object entity or a lost subject entity, respectively.

9. The method of claim 8, wherein storing distribution of historical timestamp subgraphs into a sparse matrix can be specifically achieved as:
the matrix is sized as two-dimensional N*P×N for respectively recording information of repeated or non-repeated distribution of every query fact on every historical timestamp.

10. A system for temporal knowledge graph reasoning based on distributed attention, the method comprising:
a scheduling unit, configured to recombine a temporal knowledge graph in a temporal serialization manner according to an order of timestamps in the temporal knowledge graph, and store distribution of historical timestamp subgraphs into a sparse matrix;
a processing unit, configured to construct facts of predicted timestamps using an attention mechanism and assign initial first-layer attention to the facts that are historically repeated;
an adjusting unit, configured to build second-layer attention based on statistics of historical frequency information that evolves with the timestamps, and adjust a score of the first-layer attention according to updates in knowledge; and
a training unit, configured to according to a parameter training strategy, train a model with multi-class tasks based on cross entropy loss.

11. The system of claim 10, wherein the system is configured to perform the step of recombining a temporal knowledge graph in a temporal serialization manner according to an order of timestamps in the temporal knowledge graph, and storing distribution of historical timestamp subgraphs into a sparse matrix by:
partitioning the temporal knowledge graph into a series of knowledge subgraph sequences in a chronological order, so as to dimensionally reduce representation of the temporal knowledge graph from quadruples to triples; and
according to records of the sparse matrix, predicting historical patterns of a to-be-predicted event in similar scenarios over time, and converting time consumption for historical queries into quantified space consumption.

12. The system of claim 11, wherein the system is configured to perform the step of constructing facts of predicted timestamps using an attention mechanism and assigning initial first-layer attention to the facts that are historically repeated by:
performing mask filling on sequences of historically repeated facts corresponding to each of the queries in the same batch;
computing a multi-headed attention from a query matrix Q to a key matrix after said mask filling;
supplementing deep semantic information using a fully connected feedforward neural network that comprises plural hidden units; and
performing layer normalization and residual connection on outputs from both the multi-headed attention and the feedforward neural network.

13. The system of claim 12, wherein the system is configured to perform the step of building second-layer attention based on statistics of historical frequency information that evolves with the timestamps, and adjusting a score of the first-layer attention according to updates in knowledge by:
superimposing frequency information statistics contained in new historical information;
representing the updates in knowledge according to updates in the historical frequency information, so as to adjust the initial first-layer attention;
based on the updated statistics of the historical frequency information, assigning an attention punishment to any fact that has never appeared historically; and
based on the updated statistics of the historical frequency information, assigning an attention reward to each of facts that have appeared historically.

14. The system of claim 13, wherein the system is configured to perform the step of according to a parameter training strategy, training a model with multi-class tasks based on cross entropy loss by:
initializing one or more learnable parameters of a query transformation matrix, a key transformation matrix, and a linear transformation coefficient offset;
treating reasoning-based completion of the temporal knowledge graph as the multi-class tasks each having a number of classes equal to a size of an entity set of the multi-class task;
using a cross entropy loss function and an AMSGrad optimizer to learn parameters of the multi-class tasks so as to identify the fact having the highest score and make said fact as a result of future event prediction.

15. The system of claim 14, wherein the system is configured to perform the step of performing mask filling on sequences of historically repeated facts corresponding to each of the queries in the same batch by:
using a relation-entity pair that has never appeared to fill any of the sequences that is shorter than the longest sequence in the batch, so as to generate a mask matrix using identification marks, and exclude these sequences from an attention operation.

16. The system of claim 15, wherein the system is configured to perform the step of computing a multi-headed attention from a query matrix Q to a key matrix after said mask filling by:
performing a scaled dot-product attention operation, calculating a dot product using the query matrix Q and the key matrix K, and dividing the dot product by a scaling factor to obtain a weight matrix; and
calculating a dot product using the weight matrix and a value matrix V so as to obtain a value matrix associated with a representation attention, wherein a vector of every dimension in the value matrix represents an initial distributed attention assigned to each of the historically repeated facts.

17. The system of claim 16, wherein the system is configured to recombine a temporal knowledge graph in a temporal serialization manner by:
a temporal knowledge graph [symbol] , which contains an entity set ϵ having a size of N, a relation set [symbol] having a size of P, and a timestamp set [symbol] having a size of T, is partitioned into a sequence of temporal subgraphs [symbol] ={ [symbol] ₀, [symbol] ₁, . . . , [symbol] _{T-1}} in the order of timestamps,
every subgraph is a complete, static knowledge graph, for a query fact (s, p, o, tₙ), the temporal knowledge graph reasoning task is understood as completing an incomplete fact (s, p, ?, tₙ) or (?, p, o, tₙ) based on the historical subgraph sequence { [symbol] ₜ|t<tₙ}, where ? represents a lost object entity or a lost subject entity, respectively.

18. The system of claim 17, wherein the system is configured to sort distribution of historical timestamp subgraphs into a sparse matrix by:
the matrix being sized as two-dimensional N*P×N for respectively recording information of repeated or non-repeated distribution of every query fact on every historical timestamp.

19. An electronic device, characterized in that it comprises:
one or more processors;
a memory, for storing one or more computer programs;
when the one or more computer programs are executed by the one or more processors, the one or more processors implementing the method for temporal knowledge graph reasoning based on distributed attention of claim 1.

20. A storage medium comprising computer-executable instructions, characterized in that the computer-executable instructions are used, when executed by a computer processor, to perform the method for temporal knowledge graph reasoning based on distributed attention of claim 1.
